(19) United States
(12) Patent Application Publication
(10) Pub. No.: US 2007/0266327 A1
(43) Pub. Date: Nov. 15, 2007

(54) Entertainment project management system

(76) Inventors: Josh Ritcher, Durbank, CA (US); Armen Titizian, Northridge, CA (US)

Correspondence Address: ZUBER & TAILLIEU, LLP, 9595 WILSHIRE BLVD., 9TH FLOOR, BEVERLY HILLS, CA, 90212, US

(21) Appl. No.: 11/432,362

(22) Filed: May 10, 2006

(51) Int. Cl. G06F 3/00; G06F 7/00; G06F 17/30; G06F 9/44; G06F 15/16; G06F 3/048

(52) U.S. Cl. 715/751; 707/102; 715/764; 709/206; 705/7; 707/1

(57) ABSTRACT

The present invention comprises an entertainment project management system that automates communication and collaboration between members of a project. The invention is intended for practice with a personal computer and comprises of a means to organize multiple categories of information within a department collaborating on an entertainment project; means to input and save information relevant to an entertainment project to be shared with participants in an entertainment project; means to automatically notify users participating in an entertainment project on changes and modifications to activity occurring within each department; means to use, upload, and incorporate third party software systems; and means of uploading data and information from said personal computer or external memory device onto said system.

### FIELD OF THE INVENTION

The present invention relates to an entertainment project management system employing the automation of software and computer technology to streamline and organize the creation of entertainment projects.

### BACKGROUND OF INVENTION

Entertainment projects, such as the making of a film or television program, require the coordination and collaboration of many trades and talents. A typical project may include producers, directors, lighting specialists, make-up artists, costume directors, set designers, financial people, legal staff, actors, and technical staff, to name just a few. Large volumes of data and information must be coordinated among these various departments for a duration that can span years.

Prior art methods of coordinating this large volume of data and information rely on human effort and coordination. The exchange of information requires individuals to not only perform tasks for which their area of expertise lies, but to also determine what departments or individuals may be affected and provide said departments relevant information. Manual means of coordination are required by appropriate department members to update and apprise participants of activity within a given department. Phone calls, meetings, and emails must be exchanged to keep the affected departments informed. These tasks require additional time for a participant on an entertainment project, time the participant could spend performing his area of expertise.

Prior art methods in creating an entertainment project creates a greater risk that errors and delays in an entertainment project will occur. This is because participants must take additional time to 1) make judgments as to what information is important to inform others; 2) identify which departments should receive such information; 3) identify the appropriate person within a department to inform; and 4) communicate to the appropriate department member the pertinent information; this requires the individual call, email, or arrange meetings.

Because a participant is generally occupied performing responsibilities in his area of expertise, the above tasks may not be properly completed. For example, a member of the costume department may have made a change to a costume that affected a decision of the Art Department. In his haste, the costume department member only informed the makeup department, not having the time to realize his decision also affected the Art Department. As a result, the Art Department learns for the first time of the change at a shoot. The costume change is unacceptable to the Art Department, resulting in a conflict and delay, all of which could have been avoided or minimized, had the Art Department been informed of the change earlier.

Another shortcoming of prior art methods is that they do not allow for the automatic sharing of information between different departments, even though the departments may store information and data in the same format, using the same software tools. For example, many departments store information in formats using MICROSOFT WORD or EXCEL. While each of the departments may be using the same software tools, prior art methods do not provide a central location in which the work product from these software tools can be automatically shared. This requires individuals to manually send via email, fax or postal services files from the same software tools. The delay in transmitting information can result in information not being communicated when needed. This method of sharing information does not take advantage of the fact that most departments will be using the same software tools.

A third shortcoming of prior art methods in creating entertainment projects is that there is no central location for communication between departments relating solely to the project at issue. With many members of an entertainment project being independent contractors, members must often contact one another through personal means, such as cellular phones or personal email accounts. Often times a member may be working on a project at an odd hour and may want to exchange thoughts with a second member of the project but because of the time of day, he will wait to contact the second member. In fact, the second member to whom the first member would like to speak to is working on the project at the same time. The present invention provides a communication forum dedicated to the project in which all members can collaborate and be made aware of who may be working on the project at the same time.

Accordingly, it is an object of the present invention to provide a system in which departments participating on an entertainment project can automatically share information and update the different departments on changes and modifications to a decision.

It is another object of the present invention to allow individuals to incorporate work product from third party software tools into one location so that multiple departments can share such work product.

It is also an object of the present invention to provide a central location in which departments participating in an entertainment project can have a forum in which to communicate and collaborate on a project.

### SUMMARY OF INVENTION

The present invention relates to a system geared for the entertainment industry in creation of a project. The system enables large volumes of information from multiple departments participating in an entertainment project to be automatically, and instantly shared. The invention does not require individuals to learn to operate additional software because it allows users to share work product from third party software systems for which they are already familiar. The invention further provides a means to automatically inform others of pertinent information relating to an entertainment project and provides a forum in which members of a project can communicate in real-time. The system has the ability to be used and accessed on the Internet, allowing users to access it from wherever Internet access is available.

### DESCRIPTION OF DRAWING FIGURES

FIG. 1 depicts a screen page showing a set-up page of the system.

FIG. 2 depicts a screen page showing a department area and an update log.

FIG. 3 depicts a screen page showing a department area, update log, and drag and droop feature.

FIG. 4 depicts a screen page showing a department area and instant messaging feature.

FIG. 5 depicts a screen page showing an email feature.

FIG. 6 depicts a screen page showing a department area for a location department.

### DETAILED DESCRIPTION OF A PREFERRED EMBODIMENT OF THE INVENTION

The present invention is practiced with a personal computer generally comprising of at least one processing unit in communication with one or more memory units, a display such as a monitor or screen, and a means for input of data, such as a keyboard or mouse. It is not dependant on any particular operating system. System requirements need only be sufficient to use the Internet efficiently. Accessory devices to the present invention may include wireless handheld devices such as cellular phones or personal digital assistants (PDAs).

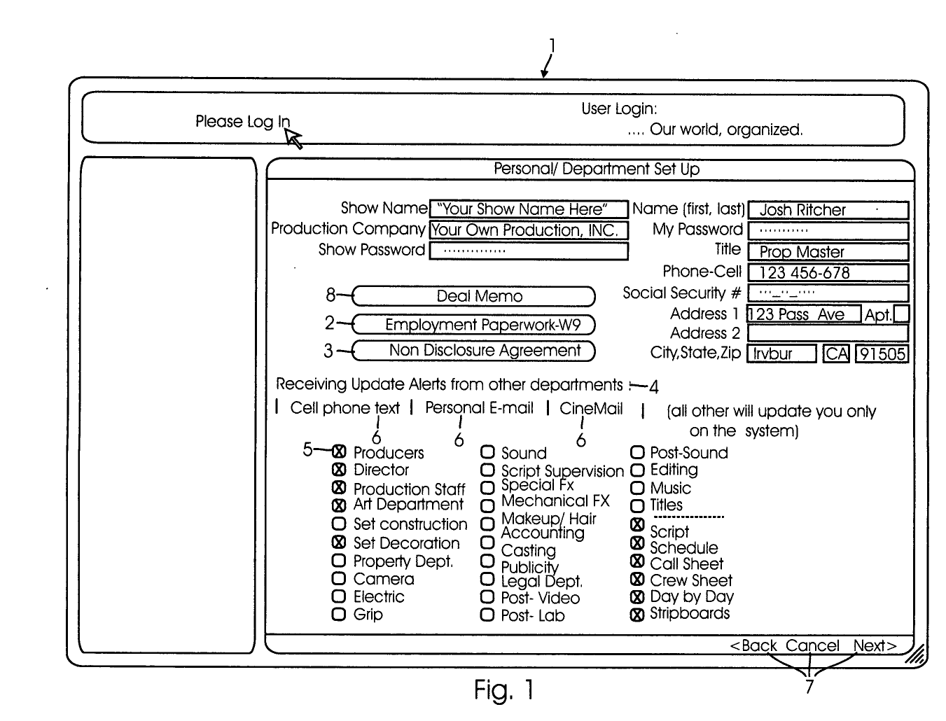

FIG. 1 depicts a set-up page 1 from the present invention that will be encountered by a user on first use of the system. It is a preliminary page that allows the user to register his personal information, such as addresses and phone numbers. The user may set up a password, which may be required to access the system.

The user may also submit necessary employment forms such as a W-9 form on the set-up page. Clicking on a W-9 button 2 will retrieve a W-9 form as a PDF file. Users that do not have a PDF viewer may download a copy of the viewer from the Internet. Additionally, system administrators may program the invention to require a user to execute a non-disclosure agreement prior to accessing the system. The user can click on a non disclosure agreement button 3 to access a file containing the non disclosure agreement. Additionally, the user may quickly access any contracts relating to the project by clicking on a deal memo button 8. Agreements particular to a project may be stored on the system and accessed via the deal memo button. The legal forms are easily accessible from the set-up page. Time is freed up for administrative staff, and delays from delivering or transmitting legal forms are minimized.

On the set-up page, the user can also select which departments he wishes to receive information or updates from in a department update selection section 4. The present invention provides the user a central location in which changes or activity within a department can be automatically announced to all of the departments participating in a project. Each user may select which departments they wish to receive updates from by clicking in the appropriate space next to a listed department. The ability to select the departments from which a user wishes to receive updates prevents bombardment of the user's mail or text files with updates not affecting the user.

A user in the Art Department, for example, may only need to receive updates from the Set Construction Department, Producers, Directors, Set Decoration Department, and Art Department. He may choose to receive updates from these departments alone, and avoid receiving information not pertaining to his responsibilities. The user simply clicks on the update selectors 5 adjacent to the department list in the department update selection section 4. The user will only receive updates from these departments. The user may choose to receive updates through a variety of means. He may receive updates by text message to a cellular device, email to a personal account, or email to a system account. Alternatively, the user may wish to receive updates only when logged onto the system. To select the medium in which the user prefers to receive updates, the user clicks the update medium buttons 6.

The user can easily navigate and return to the set-up page, allowing him to update personal information and modify update settings. Navigation buttons 7 are provided for the user to move forward and backward to access previously viewed HTML files within the system.

The user may access the system by installing software onto the hard drive of a computer. The software may provide an icon representing the system and the user may access the system by clicking the icon. The software may also allow the user to access the Internet and update fellow users of the system of activity and changes to a project. The present invention, however, is not web-based but requires a user to install the specialized software onto their computer. The Internet provides a means for users to constantly apprise each other of updates and activity within a department and project; however, the system may function entirely independent from the Internet.

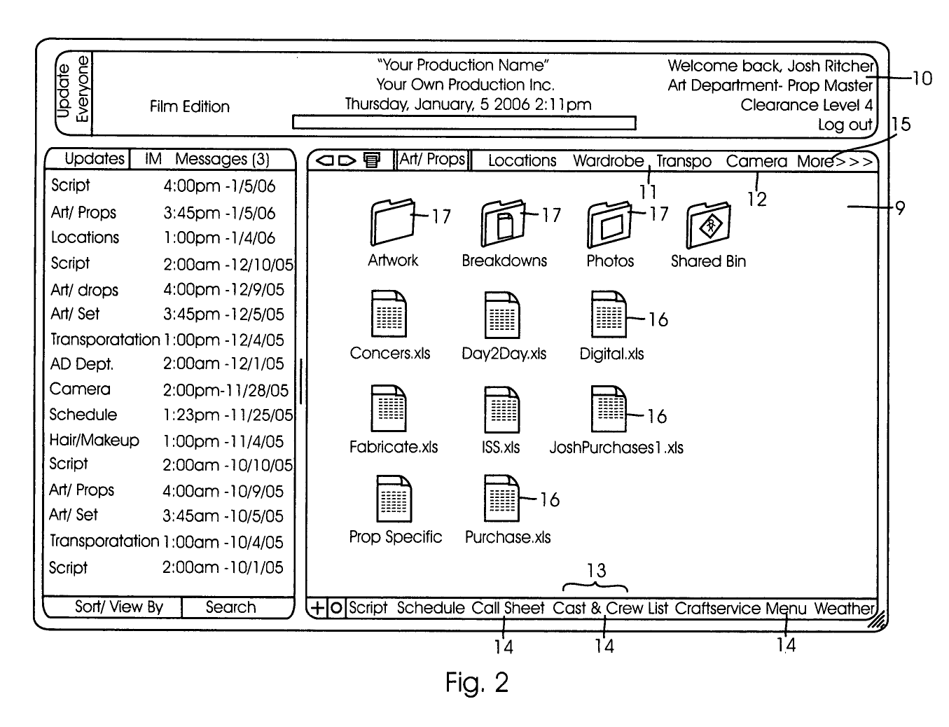

FIG. 2 shows a page representing the graphical user interface encountered by the user once logged on. Upon receipt of the user's login information, the system will automatically open to a department area 9 corresponding to the department of which the user is a member. In FIG. 2, the department area of an Art/Props department is open. Personal information regarding the user's name, title, and clearance level will appear on the identification area 10 after logging in. The clearance level of a user is defined by the appropriate person(s) and programmed into the system prior to use. Clearance levels determine the level of information to which the user has access. For example, the producer may not wish to have all users access a Legal Department area. The system will be programmed so that only users with a certain clearance level may access the Legal Department area.

A department bar 11 provides a space where the user can set up department buttons 12 for the departments he accesses most. In the example of FIG. 2, the user has customized his department bar to show department buttons for the Art/Props department, locations department, wardrobe department, transportation department, and camera department. The lower portion of the screen shows a favorites bar 13. The favorites bar holds buttons for a script, schedule, call sheet department, cast and crew list, craftservice menu, and weather. Clicking a favorite button 14 on the favorites bar provides immediate access to a page frequently accessed by the user.

Clicking on a department button 12, the user enters the department area 9 of that particular department and instantly accesses information pertaining to the department. There is a department area 9 for each of the departments using the system. From one graphical user interface, the user has immediate access to every department participating in a project. Because space on the department bar is limited, departments not placed on the department bar can be viewed and accessed when clicking on a more button 15. A drop down menu displays all of the departments not displayed on the department bar.

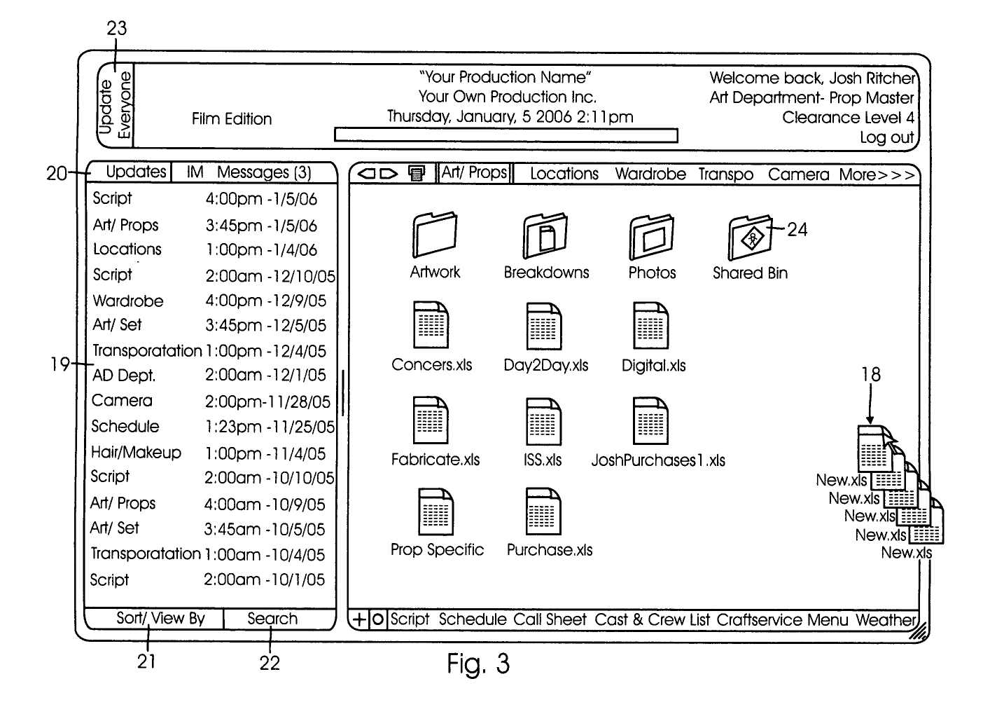

In the example of FIGS. 2-3, the user has entered the Arts/Prop Department page. On this page, files 16 relating to the activities of the Arts/Prop Department are found. Information may be further organized into folders 17. Information in a variety of formats may be imported in the system and stored as files including EXCEL files, WORD files, PHOTOSHOP images, JPEG files, TIFF files and PDF files. The system may receive files by “drag and drop” means 18, which are known in the art. FIG. 3 depicts how a user may click on a file originating from the user's computer or external memory device, drag the file into the department area and drop the file in the system. There is no need to convert the file into a format specific to the present invention because the system can import files from numerous third party software systems.

Also included on the page is an updates log 19, listing the department, time and date of updates from departments participating in the project. The departments from which the user has received updates is selected by the user on the set-up page 1. The user views the updates log by clicking on the updates feature button 20. Updates refer to any changes that have occurred within a department. These changes may be in the form of new files that have been uploaded onto the system. Updates may also be in the form of amendments and deletions made to existing files on the system.

The updated entries that have not been viewed may be distinguishable from previously viewed updates by color. The user can view an update by clicking on an entry in the updates log, which will send the user directly to the department area where the updated file(s) will be highlighted. The user clicks on the colored file to view what modification(s) have taken place. The entries in the update log may be organized by date or department and updates from departments that do not pertain to a user may be hidden from view to minimize screen clutter. A sort/view by button 21 is clicked to arrange the order in which updates are viewed. A search button 22 allows the user to locate a specific update by department, time or date.

When a user has inputted additions and modifications within his department, he can share the changes with all of the users of the system. Clicking on an update everyone button 23 instantly informs others that some sort of change within a department has taken place. The other users will see on their update log the department, time, and date for which the modification or addition has taken place. The other users may also receive alerts via the mediums they selected on their set-up page. Clicking the update everyone button will also result in the uploading of the inputted information from the user's computer onto the system.

Unless stored in a shared bin 24, files stored by a user in a department area may be viewed in a read-only format. Other users are prevented from moving, modifying, or deleting files. Only if a user places a file in the shared bin 24, can other users modify a file 16. Each department area has its own shared bin and file folders to store data within a department. A user must go to a department area to access its particular file folders and shared bin.

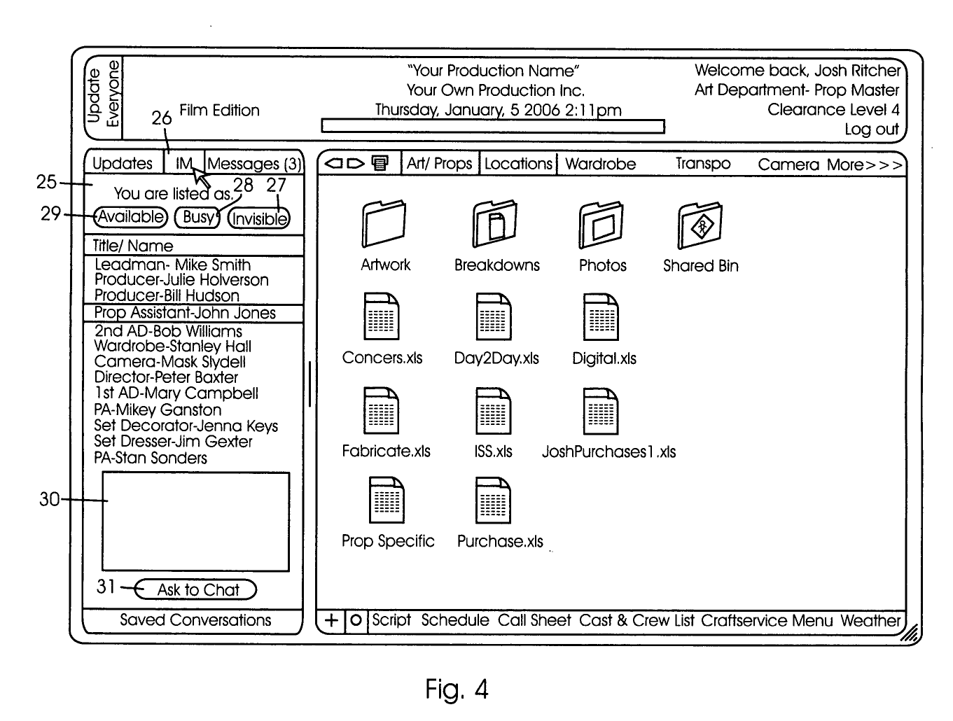

The present invention also comprises an instant messaging feature, similar to instant messaging systems known in the art. FIG. 4 depicts an instant messaging section 25 of a screen page. The instant messaging feature allows users on the system to communicate in real time with one another when they are logged onto the system. To access the instant messaging feature, the user clicks an instant messaging button 26.

When a user logs onto the system, he will be immediately listed as available. Once the instant messaging feature is accessed, a list of users concurrently on the system may be identified by name and title in the instant messaging section. If a user does not wish to be noticed, he may choose to go invisible by clicking on the invisible button 27. The invisible button prevents others from knowing he is logged on the system. Or the user may identify himself as busy, by clicking the busy button 28, and the system will indicate him as such. If a user is communicating with another user or “chatting”, the two will appear occupied. Chatting users on the system may be distinguished from available users by appearing a different color from available users. If a user wishes to make himself available for chatting, he may click the available button 29.

To chat with an individual that appears to be on the system, a user simply clicks on the users name displayed in the instant messaging section. He can type a message in a message space 30 provided in the instant messaging section and click an “ask to chat” button 31. The receiving individual has the option to reply with a standard reply button that is available on the system. For example, standard reply buttons may be provided stating “give me five minutes”, “not available to chat right now”, or “no time, sorry”. Alternatively, the individual may be available to chat and simply provide a response in the message space.

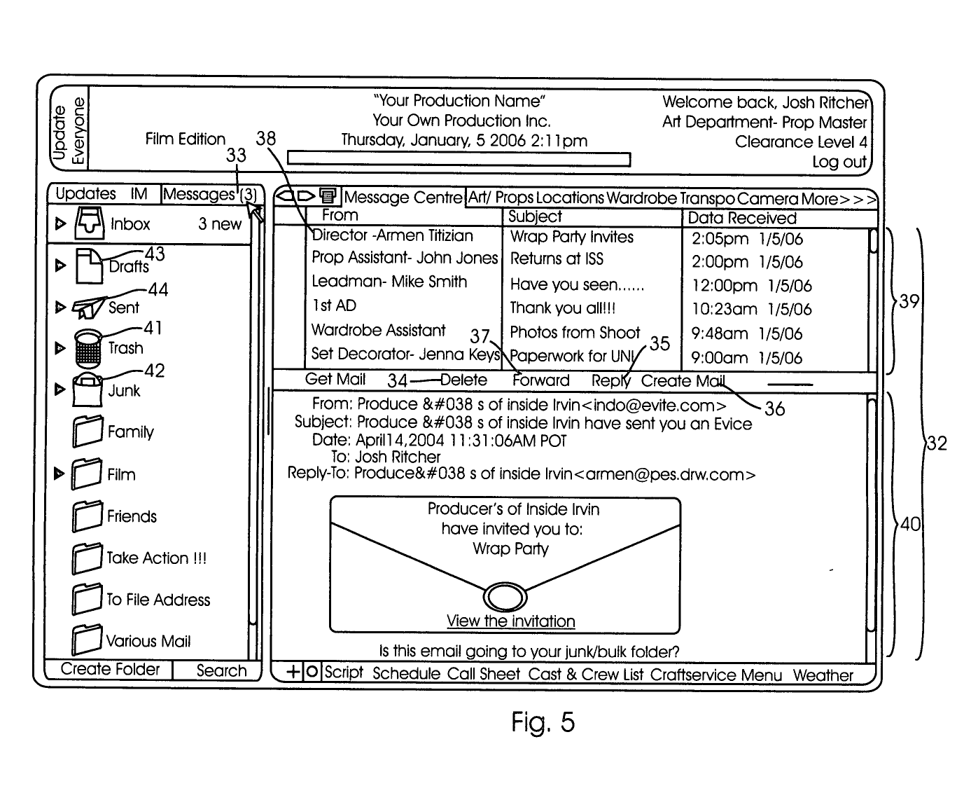

FIG. 5 shows a screen shot from an email feature 32 of the present invention. Email accounts may be provided that are hosted on the system. Users may send and receive email from the system. A user may access the email section by clicking a messages button 33, bringing up the email feature. The email feature comprises of standard email controls such as a delete button 34, reply button 35, create mail button 36 and forward button 37. The time and date of receipt of a message may be displayed. Messages may also be stored in file folders, to assist in organization. Internal emails received from users may show the name and title of the sender 38. The email feature may be configured so that a portion of the page shows a list of sent or received emails 39 and a separate portion of the page allows the user to view the content of an email message 40. Standard email features may also be provided such as a trash button 41, junk mail button 42, drafts button 43, and sent messages button 44.

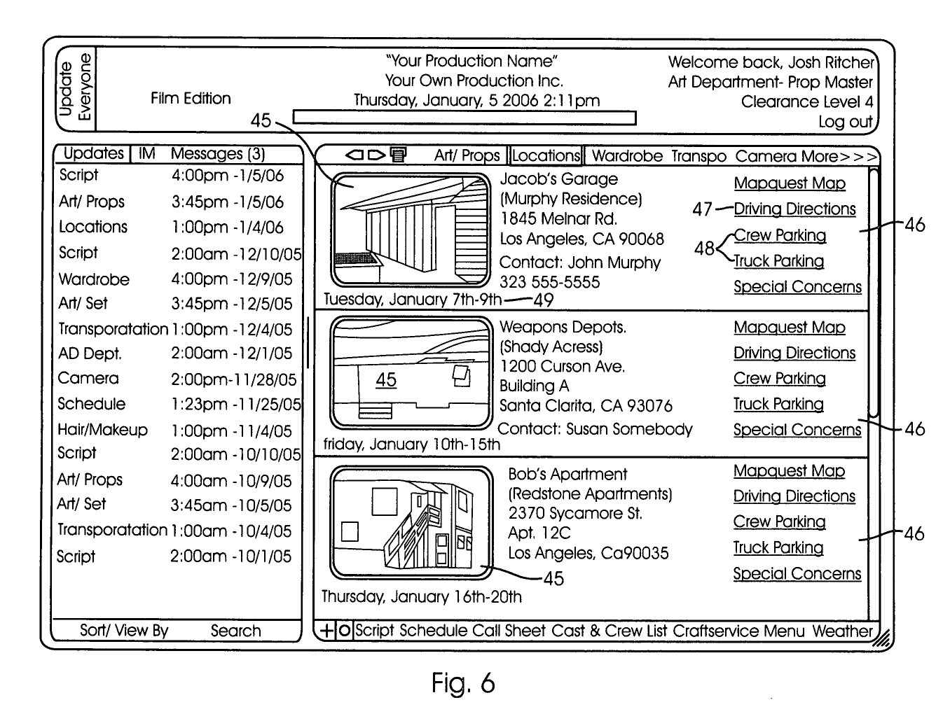

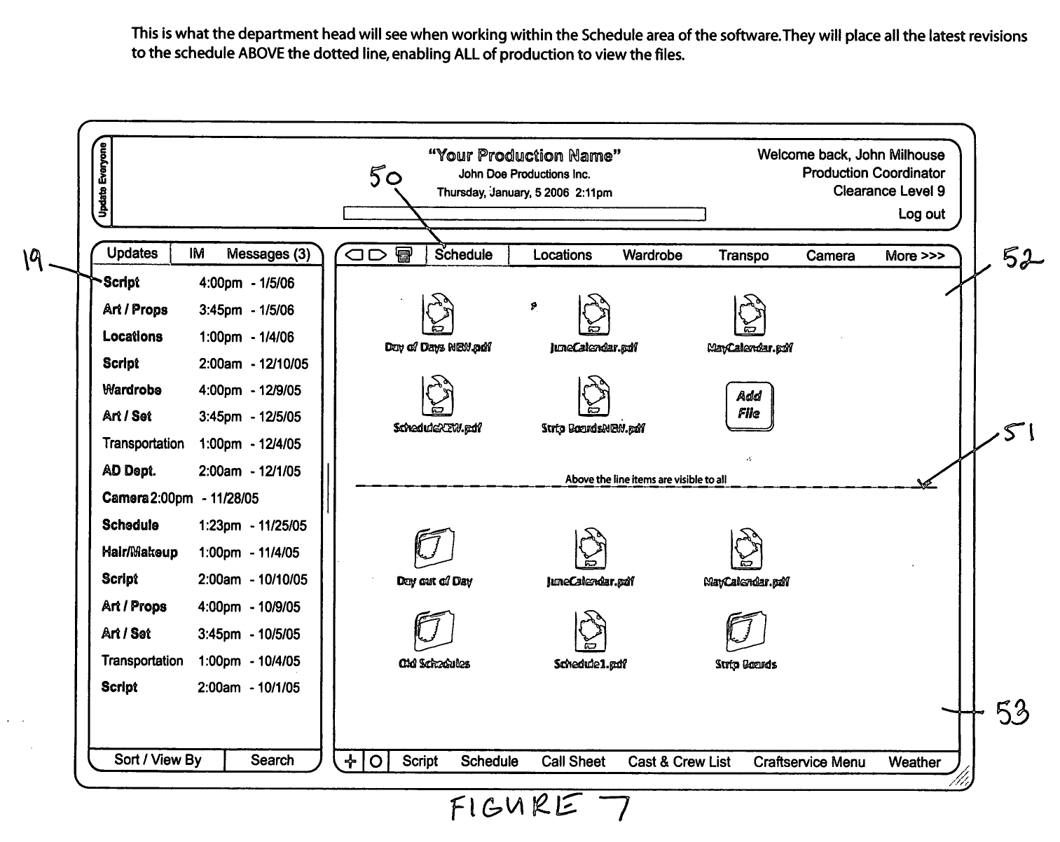

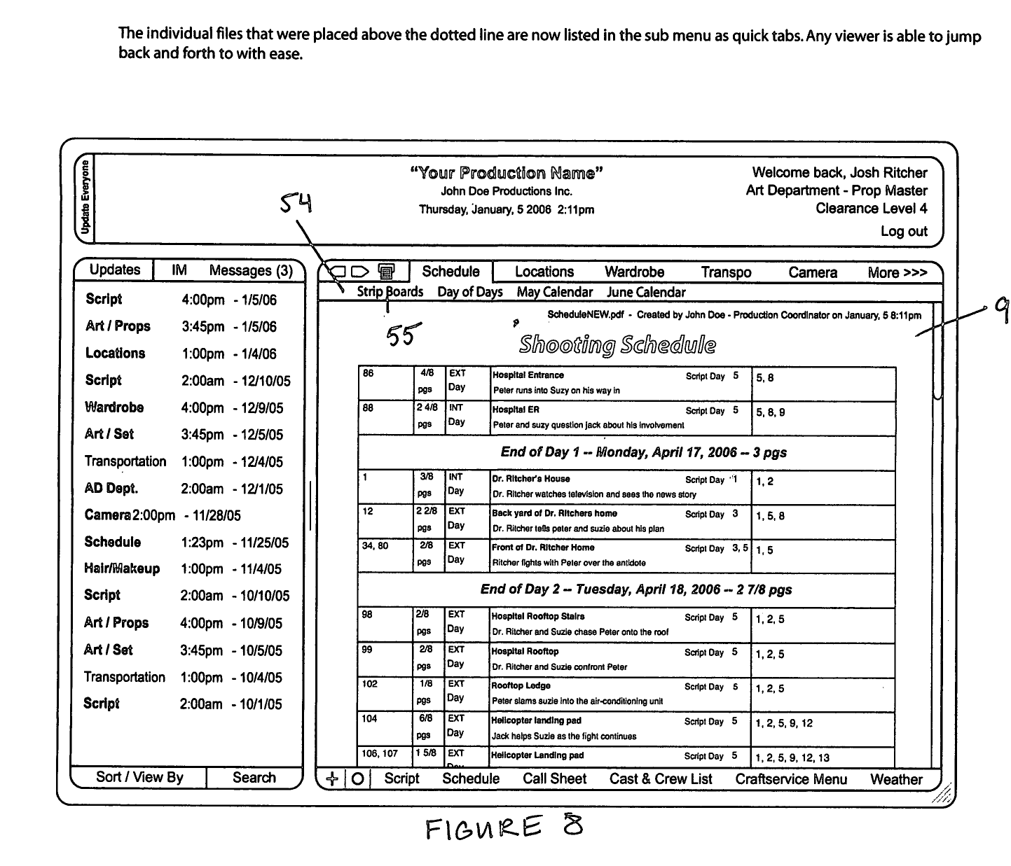

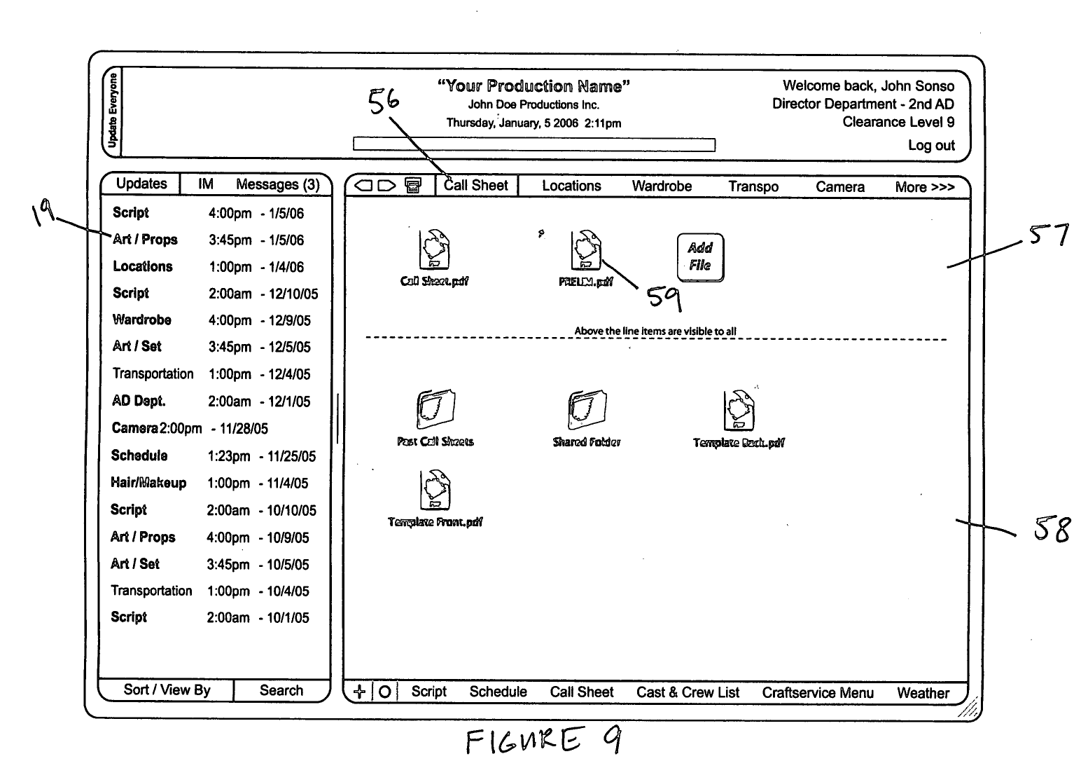

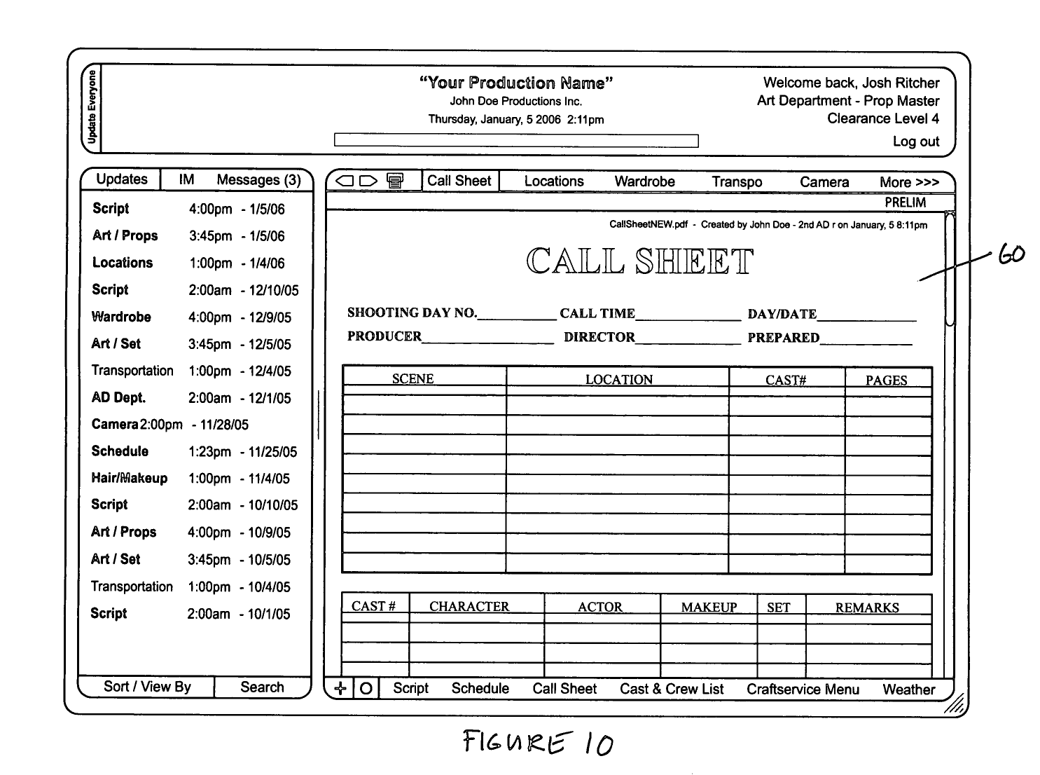

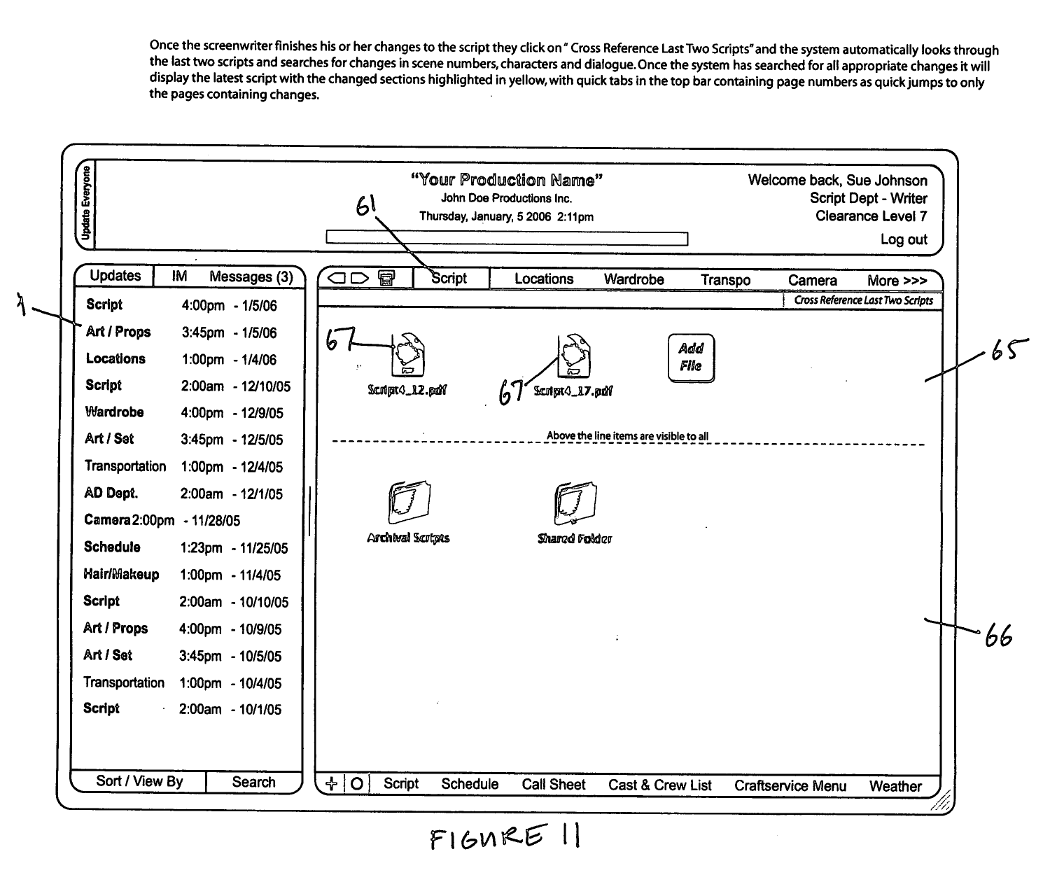

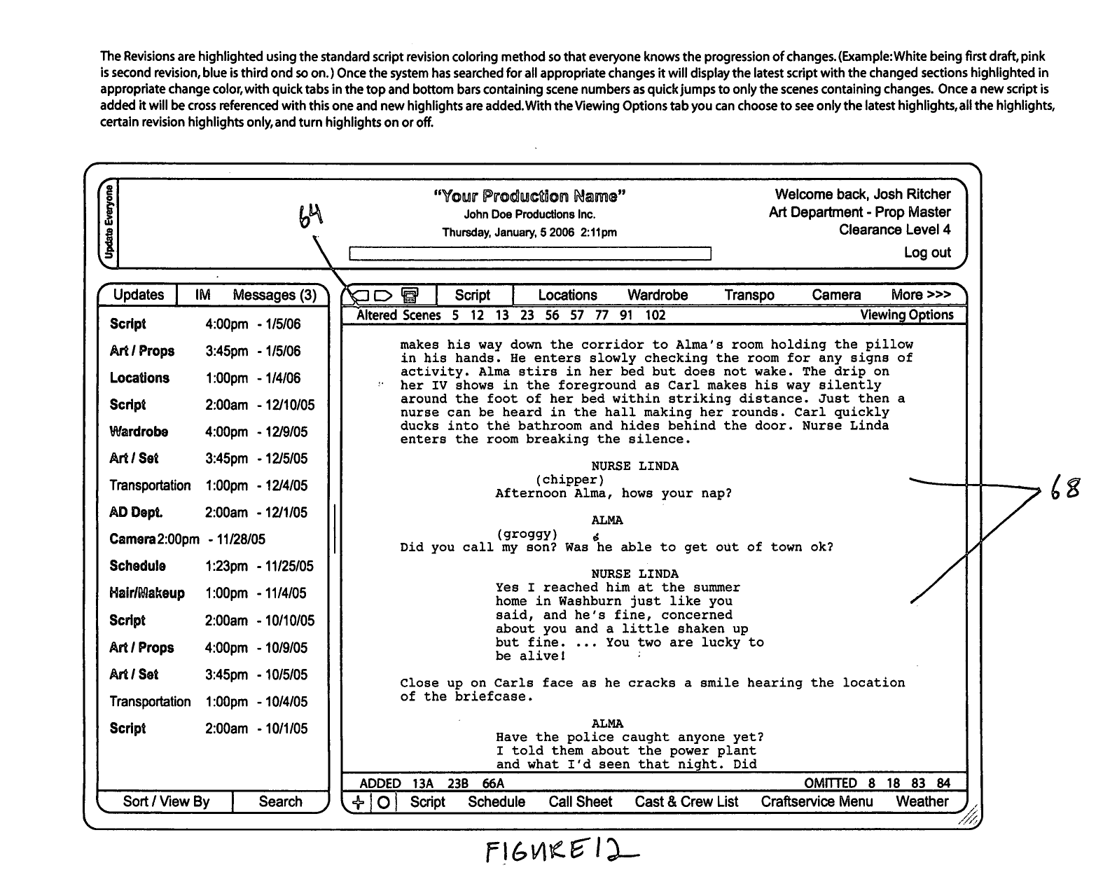

FIG. 6 shows a screen page from a department area of a locations department. Because the visual aspects of a shoot location is an important aspect in evaluating a shoot, the location department area provides means to upload visual images. Digital images 45 of locations may be uploaded into compartments 46. Information relating to the shoot may also be positioned in the respective compartment. Information relating to a shoot location may include driving directions 47, parking information 48, addresses 49, and days a crew is scheduled to shoot 50. Links from the compartments may be provided, so that clicking on the category of information such as “driving directions” brings the user to a page showing a map containing driving directions. Multiple images of a shoot location may be uploaded and accessed from the location department area.

FIG. 7 shows a screen page from a schedule department area. To access the schedule department area the user clicks on a schedule button 50. Alternatively, the user may click on the updates log 19 and click on any updates listed in the schedule department. The department area for the schedule department area may be divided in two sections, separated by a dashed line 51. Schedule files 67 placed in the upper area 52 may be viewed by all of the users. Schedule files 67 placed in the lower area 53 may only be viewed by users with appropriate clearance levels. Items may be placed in the upper and lower areas through drag and drop methods and may be imported from the user's hard drive or external memory devices.

FIG. 8 shows a screen page retrieved when the user double clicks on the Schedule button. Double clicking on the Schedule button displays sub-buttons 54 providing immediate access to schedule files located in the upper area of the schedule department area. When the user clicks on a particular sub button 54, the file for the sub button is immediately displayed in the department area. FIG. 8 shows a screen page when the user clicks a strip boards sub button 55 under the schedule button.

FIG. 9 shows a screen page from a call sheet department area. The call sheet department area is accessed either by clicking the call sheet department area button 56 or clicking on any call sheet updates listed on the updates log 19. Similar to the schedule area, the call sheet department area is separated into two areas. An upper area 57 displays files that may be viewed by all users and a lower area 58 displays files and folders visible only to users with appropriate clearance levels. A prelim.pdf file 59 is shown in the upper area. FIG. 10 shows a screen page within the call sheet department area when the user clicks on the call sheet file labeled “prelim.pdf”. A template 60 is provided for the user to enter relevant information regarding a call sheet.

FIG. 11 shows a screen page from a script department area. The script department area may be accessed by clicking on the script department button 61. Also, the script department area may be accessed by clicking on any script department updates on the updates log 19. Similar to the call sheet department area, and the schedule department area, items in the script department area that are for all users to view are placed in an upper area 65. A lower area holds files and folders for view by users with specified clearance levels 66. Files and folders may be imported in the script department area from the user's hard drive or external memory devices.

FIG. 12 shows a screen page within the script department when a user clicks on a script file 62. A script is shown and the scenes may be accessed directly by clicking on script sub buttons 63 provided below the script department button. A sub script toolbar 64 may be provided above the favorites bar, identifying any changes made to a script. Script revisions may be identified by highlighting with different identifying colors 68. The colors may correspond to the versions of the draft, for example, pink may indicate a first draft, blue may indicate a second draft, and yellow may indicate a third draft.

Regardless of the user's location within the system, the department bar 11 and favorites bar 13 is always accessible. This allows the user to quickly navigate to a desired area of the system when needed.

Multiple embodiments of the present invention may exist, customizing the system for specific forms of entertainment projects. The department buttons may be geared towards the production of a film, a television project, an advertisement, a music video, or a theatrical stage performance.

In summary, the present invention is a novel, inventive entertainment project management system that improves the efficiency in which entertainment projects are created. With respect to the above description, it is to be realized that variations are deemed readily apparent and obvious to one skilled in the art, and all equivalent relationships to those illustrated in the drawings and described in the specification are intended to be encompassed by the present invention. While the specification describes a system pertaining to a film or television project, various embodiments exist that fall under the scope of this patent, including, but not limited to a management system intended for use on advertising projects, theatrical projects, or music video projects.

Therefore, the foregoing is considered as illustrative only of the principles of the invention. Further, since numerous modifications and changes will readily occur to those skilled in the art, it is not desired to limit the invention to the exact operation shown and described, and accordingly, all suitable modifications and equivalents may be resorted to, while still falling within the scope of the invention.

1. An entertainment project management system for practice on a personal computer comprising:
Multiple department buttons to access department areas of departments participating in an entertainment project from a single graphical user interface;
means to organize multiple categories of information concerning each department in said department areas;
means to input and save information relevant to an entertainment project to be shared with participants in the entertainment project;
means to automatically notify users on changes and modifications to activity occurring within each department;
and means of uploading data and information from said personal computer or external memory device onto said system.

2. The entertainment project management system of claim 1 wherein said means to automatically notify users on changes and modifications to activity occurring within each department include text message means.

3. The entertainment project management system of claim 1 wherein said means to automatically notify users on changes and modifications to activity occurring within each department include electronic mail means.

4. The entertainment project management system of claim 1 further comprising means to access, store and send emails to and from the system.

5. The entertainment project management system of claim 1 further comprising means to communicate with other users of the system in real time.

6. The entertainment project management system of claim 1 further comprising means to access the Internet.

7. The entertainment project management system of claim 1 wherein users participating on the project notifies other participants of changes and modifications within each department via text messages and emails from the system.

8. The entertainment project management system of claim 1 wherein one of said department buttons includes access to a department area of a location department of an entertainment project;
On accessing of said location department, information and digital images of a shoot may be uploaded for all users of the system to view.

9. The entertainment project management system of claim 1 wherein one of said department buttons includes access to a department area of a schedule department of an entertainment project;
On accessing of said schedule department, schedules may be accessed pertaining to the entertainment project.

10. The entertainment project management system of claim 1 wherein one of said department buttons includes access to a department area of a call sheet department of an entertainment project;
On accessing of said call sheet department, information pertaining to the call sheet department may be accessed.

11. The entertainment project management system of claim 1 wherein one of said department buttons includes access to a department area of a script department of an entertainment project;
on accessing of said script department, scripts pertaining to the entertainment project may be accessed.

12. The entertainment project management system of claim 1 further comprising means of restricting access to locations within the system, depending on security clearance levels.

13. The entertainment project management system of claim 1 wherein said department buttons to access activity and information from multiple departments are limited to departments pertaining to a film project.

14. The entertainment project management system of claim 1 wherein said department buttons to access activity and information from multiple departments are limited to departments pertaining to a television project.

15. The entertainment project management system of claim 1 wherein said department buttons to access activity and information from multiple departments are limited to departments pertaining to an advertisement project.

16. The entertainment project management system of claim 1 wherein said department buttons to access activity and information from multiple departments are limited to departments pertaining to a music video project.

17. The entertainment project management system of claim 1 wherein said department buttons to access activity and information from multiple departments are limited to departments pertaining to a theatrical stage project.

18. The entertainment project management system of claim 1 further comprising means to use, upload, and incorporate third party software tools in said system.
